(19) United States
(12) Patent Application Publication
(10) Pub. No.: US 2011/0217959 A1
(43) Pub. Date: Sep. 8, 2011

(54) Alternative process determining method, alternative process determining apparatus, recording medium, and mobile telephone terminal

(75) Inventors: Masahide Noda, Kawasaki (JP); Kazuki Matsui, Kawasaki (JP)

(73) Assignee: FUJITSU LIMITED, Kawasaki (JP)

(21) Appl. No.: 13/067,162

(22) Filed: May 12, 2011

Related U.S. Application Data
(63) Continuation of application No. PCT/JP2008/071344, filed on Nov. 25, 2008.

(51) Int. Cl. H04M 3/42

(52) U.S. Cl. 455/414.1

(57) ABSTRACT

A method for determining, by a computer, an alternative process includes receiving from a transmitting side terminal a communication request containing a first combination of a receiving side identifier information of a mobile phone terminal and a transmitting side identifier information of the transmitting side terminal and, determining the alternative process to be performed, instead of relaying the communication request to the mobile phone terminal in response to the communication request, corresponding to the transmitting side identifier information in the communication request based on the first combination of the receiving side identifier information and the transmitting side identifier information in the communication request and alternative process information specifying the alternative process to be performed based on a second combination of the receiving side identifier information of the mobile phone terminal and the transmitting side identifier information of the transmitting side terminal managed in an alternative process information manager.

### CROSS-REFERENCE TO RELATED APPLICATION

The present application is a U.S. continuation application filed under 35 USC 111(a) claiming benefit under 35 U.S.C. 120 and 365(c) of PCT International application No. PCT/JP2008/071344, filed on Nov. 25, 2008, the entire contents of which are incorporated herein by reference.

### FIELD

The embodiments discussed herein are related to an alternative process determining method, an alternative process determining apparatus, a recording medium, and a mobile phone terminal.

### BACKGROUND

Mobile phones are widely used for business operations in various business settings owing to many benefits of having the mobile phones. For example, the mobile phones may allow business persons to quickly contact customers at all times. However, if a business person has left his or her mobile phone at home and has no mobile phone at hand, he or she would not notice having incoming calls from his or her customers.

The mobile phones are configured to store, whether it is business or personal, confidential data. If, by any chance, this business person has left his mobile phone in a public area, the confidential data stored in the mobile phone may be leaked or misused.

Thus, the mobile phones are generally provided with a so-called “remote lock” or “remote wipe” function (hereinafter called a “security function”). The “remote lock” function remotely disables temporal operability of the mobile phone by remote operation. The “remote lock” function remotely disables temporal operability of the mobile phone. Examples of such security technologies are disclosed in Japanese Laid-Open Patent Application Publication No. 2008-11218, Japanese Laid-Open Patent Application Publication No. 2007-60023, and Japanese Laid-Open Patent Application Publication No. 2007-4723.

With this remote lock function, the risk of deliberate misuse of the mobile phone may be reduced even if the mobile phone falls into wrong hands. However, even if the mobile phone has this security function, the user may not notice incoming calls.

There is a voice message service or a call forwarding service for checking or receiving incoming calls addressed to a user of a mobile phone when the user is in a location without having his or her mobile phone at hand.

The voice message service is a service to receive and answer an incoming call addressed to the mobile phone of the user who utilizes the voice message service when the user is unable to take calls and stores voice messages at the voice mail center. The user of the voice message service may listen to the messages recorded at the voice mail center via the user's mobile phone or other phone.

The call forwarding service is a service to forward incoming calls to another mobile phone or other phone that has been registered in advance.

### SUMMARY

According to an aspect of the embodiment, there is provided a method for determining an alternative process performed by a computer. The method includes receiving a communication request addressed to a mobile phone terminal from a transmitting side terminal, the communication request containing a first combination of a receiving side identifier information of the mobile phone terminal and a transmitting side identifier information of the transmitting side terminal; and determining the alternative process to be performed, instead of relaying the communication request received from the transmitting side terminal to the mobile phone terminal in response to the communication request received from the transmitting side terminal, corresponding to the transmitting side identifier information contained in the communication request based on the first combination of the receiving side identifier information and the transmitting side identifier information contained in the communication request and alternative process information specifying the alternative process to be performed based on a second combination of the receiving side identifier information of the mobile phone terminal and the transmitting side identifier information of the transmitting side terminal managed in an alternative process information manager.

The object and advantages of the invention may be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating a configuration example of a communication system according to a first embodiment;

FIG. 2 is a diagram illustrating a hardware configuration example of a terminal management server in the communication system according to the first embodiment;

FIG. 3 is a diagram illustrating a hardware configuration example of a mobile phone terminal in the communication system according to the first embodiment;

FIG. 4 is a sequence diagram illustrating a sequence of processes carried out in the communication system according to the first embodiment;

FIG. 5 is a diagram illustrating a configuration example of an address book of the mobile phone terminal in the communication system according to the first embodiment;

FIG. 6 is a diagram illustrating a configuration example of a terminal information table of the terminal management server in the communication system according to the first embodiment;

FIG. 7 is a flowchart illustrating a determining process in which the terminal management server determines an alternative process in the communication system according to the first embodiment;

FIG. 8 is a sequence diagram illustrating a sequence of processes to deactivate unattended mode setting of the mobile phone terminal in the communication system according to the first embodiment;

FIG. 9 is a diagram illustrating a configuration example of a communication system according to a second embodiment;

FIG. 10 is a sequence diagram illustrating a sequence of processes carried out in the communication system according to the second embodiment;

FIG. 11 is a diagram illustrating a configuration example of an address book of the mobile phone terminal in the communication system according to the second embodiment;

FIG. 12 is a diagram illustrating a configuration example of a terminal information table in the communication system according to the second embodiment;

FIG. 13 is a sequence diagram illustrating a determining process in which the terminal management server determines an alternative process in the communication system according to the second embodiment;

FIG. 14 is a diagram illustrating a configuration example of a communication system according to a third embodiment;

FIG. 15 is a diagram illustrating a configuration example of an address book of the mobile phone terminal in the communication system according to the third embodiment; and

FIG. 16 is a diagram illustrating a configuration example of a terminal information table in the communication system according to the third embodiment.

### DESCRIPTION OF EMBODIMENTS

In the voice message service, however, the user may need to perform a predetermined operation every time the user checks to see whether the user has received recorded messages. Further, since not all the callers leave messages at the voice mail center, the user may not be able to determine whether the user has received calls from such callers.

In the call forwarding service, all the incoming calls addressed to the user's mobile phone may be forwarded to the registered phone regardless of their levels of importance. Further, if the user forgets to deactivate the setting of the call forwarding service, all the incoming calls are still forwarded to the registered phone after the user gets the user's mobile phone back.

According to an aspect of the embodiments, there are provided an alternative process determining method, an alternative process determining apparatus, a recording medium having a computer program embodied therein executing the alternative process determining method, and a mobile phone terminal that may suitably respond to a communication request addressed to the mobile phone terminal even if the mobile phone terminal is not in the hands of an owner of the mobile phone terminal.

In the following, preferred embodiments are described with reference to the accompanying drawings.

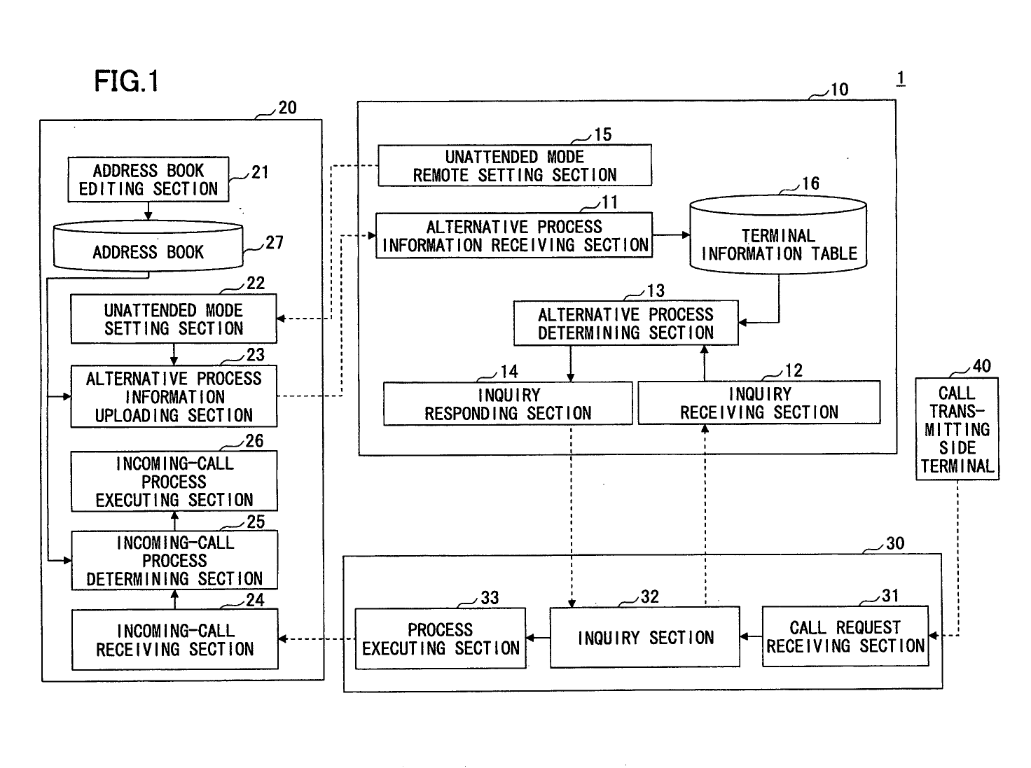

FIG. 1 is a diagram illustrating a configuration example of a communication system 1 according to a first embodiment. As illustrated in FIG. 1, the communication system 1 includes a terminal server 10, a mobile phone terminal 20, a call controller 30, and a call transmitting side terminal 40.

The call transmitting side terminal 40 is a transmitting side terminal with which a caller communicates with (or calls) the mobile phone terminal 20 via a communication network (e.g., a telephone network or an Internet protocol (IP) network). Examples of the call transmitting side terminal 40 include a mobile phone terminal, a fixed-line telephone machine, a personal computer (PC), and a personal digital assistance (PDA).

The mobile phone terminal 20 is a receiving side mobile phone terminal configured to receive incoming calls in the communications with the call transmitting side terminal 40. Note that the mobile phone terminal 20 is illustrated as a mobile phone terminal for receiving only in the communication system 1 according to the first embodiment; however, the mobile phone terminal 20 is not limited to a receive-only terminal.

The call controller 30 is configured to control calls in the communications between the call transmitting side terminal 40 and the mobile phone terminal 20 in the communication system 1 according to the first embodiment. Specific examples of the call controller 30 include a telephone switchboard or a voice over Internet protocol (VoIP) gateway, or a system that includes plural devices having the telephone switchboard and the VoIP gateway.

The terminal management server 10 is a computer configured to determine an appropriate process in response to a call request transmitted from the call transmitting side terminal 40 in the communication system 1. Specifically, the call controller 30 transmits, on receiving the call request from the call transmitting side terminal 40, an inquiry about an appropriate process corresponding to the call request to the terminal management server 10. The call controller 30 executes the appropriate process corresponding to the call request from the call transmitting side terminal 40 based on a response to the inquiry about the appropriate process corresponding to the call request of the call transmitting side terminal 40 received from the terminal management server 10.

Next, functions of the devices in the communication system 1 according to the first embodiment are described with reference to FIG. 1. As illustrated in FIG. 1, the mobile phone terminal 20 includes an address book editing section 21, an unattended mode setting section 22, an alternative process information uploading section 23, an incoming-call receiving section 24, an incoming-call process determining section 25, and an incoming-call process executing section 26.

The address book editing section 21 is configured to edit an address book 27 based on an instruction input by an operator of the mobile phone terminal 20. The address book 27 is an information manager that is generally called a telephone directory or an address book. The address book 27 is configured to register a name of a communication partner and communication identifier information (i.e., a phone number, an email address, etc.) for each entry (i.e., candidate of communication partner). The address book 27 of the mobile phone terminal 20 illustrated in the first embodiment has a format configured to register alternative process information for each entry. Note that the alternative process information indicates contents of an alternative process to be performed by the call controller 30 in response to the communication request (i.e., call request in this example) transmitted from the call transmitting side terminal 40 instead of carrying out a relay process to relay the communication request to the mobile phone terminal 20.

The unattended mode setting section 22 is configured to activate (ON) or deactivate (OFF) an “unattended mode” setting of the mobile phone terminal 20. Note that the “unattended mode” is setting information indicating as to whether the owner of the mobile phone terminal 20 is able to use the mobile phone terminal 20. The unattended mode (ON) indicates a situation where the owner of the mobile phone terminal 20 may not have access to or be able to utilize the mobile phone terminal 20. The unattended mode (ON) indicates a situation where the owner of the mobile phone terminal 20 may have access to or be able to utilize the mobile phone terminal 20. The value (ON or OFF) of the unattended mode is recorded in a RAM 202 or a volatile RAM 203.

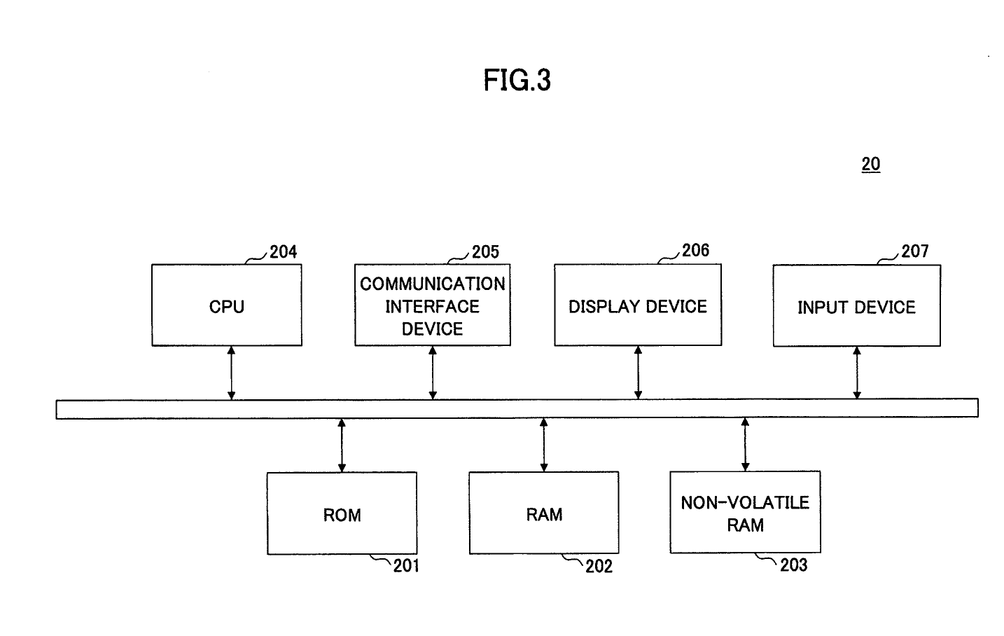

The unattended mode setting of the mobile phone terminal 20 is directly activated or deactivated by operating a set of buttons of an input device 207 (see FIG. 3) of the mobile phone terminal 20 or by remotely operating the unattended mode setting of the mobile phone terminal 20 via the terminal management server 10. For example, if the owner of the mobile phone terminal 20 deliberately leaves the mobile phone terminal 20 at home or somewhere in the distance, it may be convenient for the owner to activate the unattended mode setting by operating the buttons of the mobile phone terminal 20. If, on the other hand, the owner of the mobile phone terminal 20 unintentionally leaves the mobile phone terminal 20 at home or somewhere in the distance, it may be convenient for the owner to activate the unattended mode setting by remotely operating the unattended mode setting of the mobile phone terminal 20 via the terminal management server 10.

When the unattended mode setting of the mobile phone terminal 20 is activated (ON), the alternative process information uploading section 23 uploads (transmits) the alternative process information contained in the address book 27 and a phone number of the mobile phone terminal 20 to the terminal management server 10. When the unattended mode setting of the mobile phone terminal 20 is deactivated (OFF), the alternative process information uploading section 23 requests the terminal management server 10 to delete the uploaded alternative process information.

The incoming-call receiving section 24 of the mobile phone terminal 20 is configured to receive the call request from the call transmitting side terminal 40 via the call controller 30. The incoming-call process determining section 25 is configured to determine an appropriate process to be performed based on the alternative process information contained in the address book 27 in response to the call request from the call transmitting side terminal 40 received via the incoming-call receiving section 24. The incoming-call process executing section 26 is configured to perform the appropriate process determined by the incoming-call process determining section 25.

The call controller 30 includes a call request receiving section 31, an inquiry section 32, and a process executing section 33. The call request receiving section 31 is configured to directly or indirectly receive (via a relay device) the call request addressed to the mobile phone terminal 20 that is transmitted from the call transmitting side terminal 40. The inquiry section 32 is configured to transmit an inquiry about an appropriate process corresponding to the received call request addressed to the mobile phone terminal 20 to the terminal management server 10. The process executing section 33 is configured to perform an appropriate process based on a determined result on the inquiry about the process to be preformed in response to the received call request addressed to the mobile phone terminal 20.

The terminal management server 10 includes an alternative process information receiving section 11, an inquiry receiving section 12, an alternative process determining section 13, an inquiry responding section 14, an unattended mode remote setting section 15, and a terminal information table 16.

The alternative process information receiving section 11 is configured to receive the alternative process information uploaded by the alternative process information uploading section 23 of the mobile phone terminal 20 and store the received alternative process information in the terminal information table 16. The inquiry receiving section 12 is configured to receive the inquiry received from the inquiry section 32 of the call controller 30. The alternative process determining section 13 is configured to determine an appropriate process (alternative process) to be executed corresponding to the call request based on the terminal information table 16 in response to the inquiry received from the inquiry receiving section 12. The inquiry responding section 14 is configured to transmit a determined result assigned by the alternative process determining section 13 to the inquiry section 32 of the call controller 30.

The unattended mode remote setting section 15 is configured to transmit a request for activating (ON) or deactivating (OFF) the “unattended mode” setting in the unattended mode setting section 22 of the mobile phone terminal 20 based on an instruction input by the user (i.e., the owner of the mobile phone terminal 20). The instruction assigned to the unattended mode remote setting section 15 may be input by the user via a push-button telephone. Alternatively, the instruction assigned to the unattended mode remote setting section 15 may be input by the user via a Web interface. In this case, the unattended mode remote setting section 15 may be accessible from a Web browser of a not-illustrated personal computer (PC) connected via the terminal management server 10 and the network. The unattended mode remote setting section 15 receives the instruction to activate (ON) or deactivate (OFF) the unattended mode setting input via an unattended mode setting web page displayed on the Web browser.

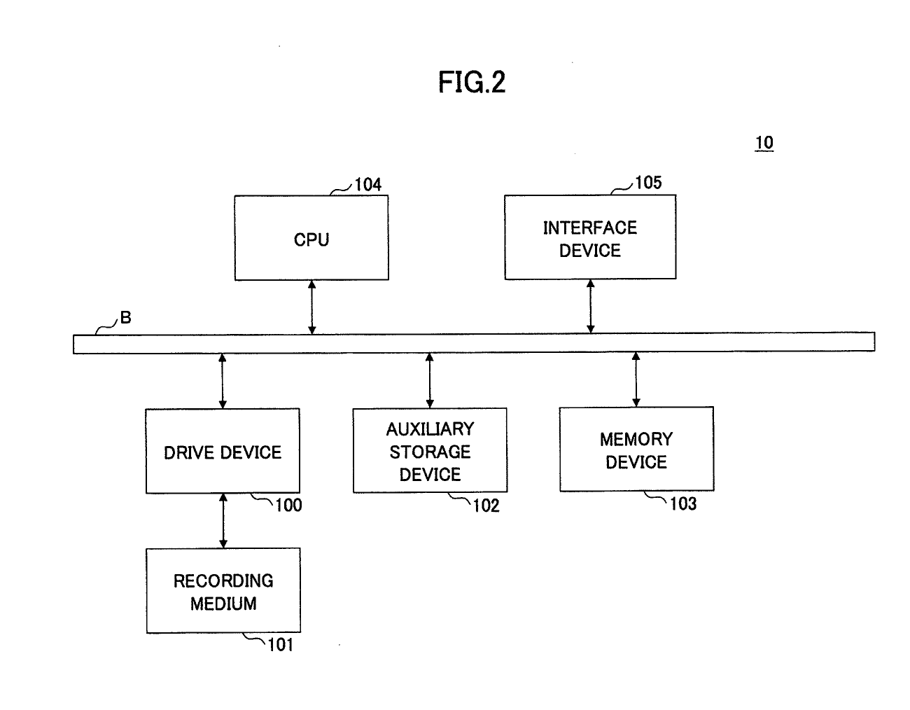

FIG. 2 is a diagram illustrating a hardware configuration example of the terminal management server 10 in the communication system 1 according to the first embodiment. As illustrated in FIG. 2, the terminal management server 10 includes a drive device 100, an auxiliary storage device 102, a memory device 103, a CPU 104, and an interface device 105 that are mutually connected via a bus B.

A computer program configured to implement various processes in the terminal management server 10 is provided by a recording medium 101 such as a CD-ROM that stores the computer program. When the recording medium 101 storing the computer program is placed in the drive device 100, the computer program is installed in the auxiliary storage device 102 from the recording medium 101 via the drive device 100. Note that the computer program may not be necessarily installed from the recording medium 101, but may be installed by downloading it from other computers via the network. The auxiliary storage device 102 stores desirable files, data, and the like in addition to the installed computer program. For example, the terminal information table 16 is stored in the auxiliary storage device 102.

The memory device 103 is configured to read, on receiving an activating instruction to activate the computer program, the computer program from the auxiliary storage device 102 and store the read computer program. The CPU 104 is configured to execute functions of the terminal management server 10 based on the computer program stored in the memory device 103. The interface device 105 is used as an interface to connect the terminal management server 10 to the network.

FIG. 3 is a diagram illustrating a hardware configuration example of the mobile phone terminal 20 in the communication system 1 according to the first embodiment. As illustrated in FIG. 3, the mobile phone terminal 20 includes a ROM 201, a RAM 202, a non-volatile RAM 203, a CPU 204, a communication interface device 205, a display device 206 and an input device 207.

A computer program configured to implement various processes in the mobile phone terminal 20 is installed in the ROM 201 or the non-volatile RAM 203 of the mobile phone terminal 20. For example, if the computer program is preinstalled in the mobile phone terminal 20 before shipping, the computer program is generally stored in the ROM 201. If the computer program is downloaded via the Internet or the like, the downloaded computer program is stored in the non-volatile RAM 203. Note that the ROM 201 or the non-volatile RAM 203 may store, in addition to the computer program, various data utilized by the computer program. For example, the address book 27 is stored in the non-volatile RAM 203.

The RAM 202 is configured to store, on receiving an activating instruction to activate the computer program, the computer program by reading it from the ROM 201 or the non-volatile RAM 203. The CPU 204 is configured to execute functions of the mobile phone terminal 20 based on the computer program stored in the RAM 202. The communication interface device 205 is a component utilized for transmitting or receiving calls or electronic mails and includes an antenna and radio communication modules and the like. The display device 206 is a display monitor such as a liquid crystal panel. The input device 207 includes a set of buttons that are operated by the user so that the input device 207 receives an instruction assigned by the user.

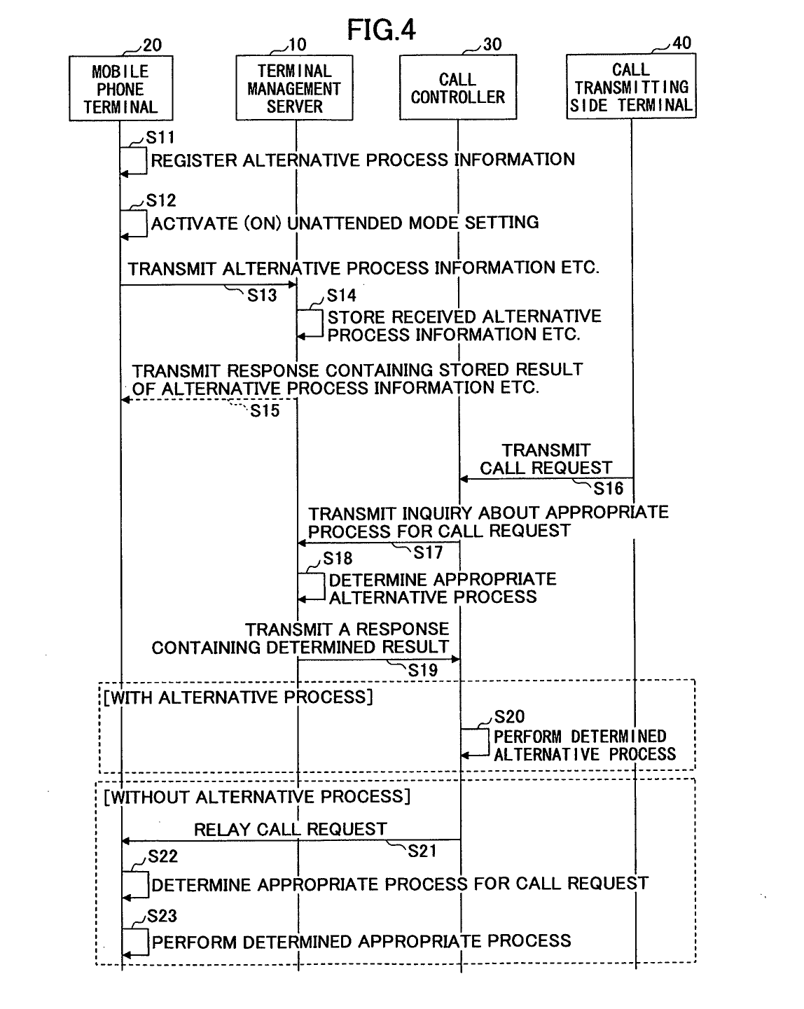

Next, a sequence of processes carried out in the communication system 1 according to the first embodiment is described. FIG. 4 is a sequence diagram illustrating a sequence of processes carried out in the communication system according to the first embodiment.

First, the address book editing section 21 registers alternative process information and the like in the address book 27 based on an instruction input by the owner (i.e., operator) of the mobile phone terminal 20 (step S11).

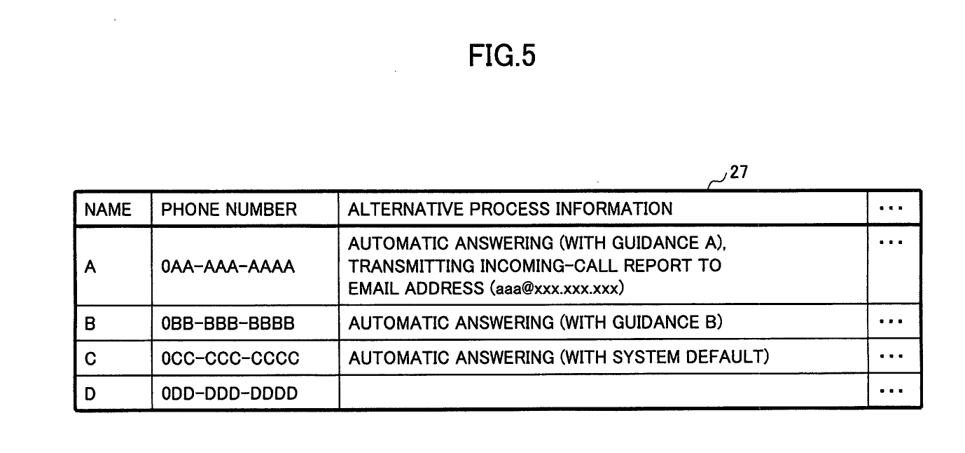

FIG. 5 is a diagram illustrating a configuration example of the address book 27 of the mobile phone terminal 20 in the communication system 1 according to the first embodiment. As illustrated in FIG. 5, the address book 27 is configured to register a name, a phone number, and alternative process information for each entry.

Examples of the alternative process information include automatic answering (i.e., automatic announcement) to the incoming call with user defined or system defined audio guidance, transmitting an incoming call report to a specific email address, automatic answering (i.e., automatic announcement) to the incoming call when the user receives the incoming call while the user is in a public place or out of the service area, and transmission of the incoming call to a specified telephone number. As illustrated in FIG. 5, alternative process information for an incoming call from a phone number (i.e., call transmitting side phone number) “0AA-AAA-AAAA” of a person A registered in the address book 27 includes automatic answering (i.e., automatic announcement) to the incoming call from the person A with user defined guidance A (i.e., one example of the user defined audio guidance), and transmission of the incoming call report to a specific address (e.g., email address of a PC at work) “aaa@xxx.xxx.xxx” other than that of the mobile phone terminal 20 of the user (owner). Further, alternative process information for an incoming call from a phone number “0BB-BBB-BBBB” of a person B registered in the address book 27 includes automatic answering (i.e., automatic announcement) to the incoming call from the person B with user defined guidance B (i.e., one example of the user defined audio guidance). Moreover, alternative process information for an incoming call from a phone number (i.e., call transmitting side phone number) “0CC-CCC-CCCC” of a person C registered in the address book 27 includes automatic answering (i.e., automatic announcement) to the incoming call from the person C with system defined guidance (i.e., default audio guidance predetermined in the system).

Note that the alternative process information illustrated in FIG. 5 is defined in a natural language for convenience; however, the alternative process information may be in a descriptive format suitable for a computer program such as predetermine script language syntax or predetermined process code.

The unattended mode setting section 22 activates (ON) the unattended mode setting of the mobile phone terminal 20 by the user's operation of the buttons of the mobile phone terminal 20 or in response to a request for activating the unattended mode setting transmitted from the unattended mode remote setting section 15 of the terminal management server 10 (step S12). Note that step 12 is executed asynchronously with step S11. The following is a specific example for activating the unattended mode setting of the mobile phone terminal 20 in response to the request transmitted from the unattended mode remote setting section 15 of the terminal management server 10. For example, the user (owner) of the mobile phone terminal 20 may accidentally leave the mobile phone terminal 20 at home, and inputs an instruction for activating the unattended mode setting of the mobile phone terminal 20 to the unattended mode remote setting section 15 via a telephone machine or the PC at work.

In response to the activation (ON) of the unattended mode setting of the mobile phone terminal 20, the alternative process information uploading section 23 uploads (transmits) the alternative process information and the phone number of the corresponding entry registered in the address book 27 to the terminal management server 10 (step S13). In this step, the alternative process information uploading section 23 may also upload (transmit) the phone number of the mobile phone terminal 20 recorded in the ROM 201 or non-volatile RAM 203 to the terminal management server 10. Note that the uploading process may be performed by utilizing an Open Mobile Alliance (OMA) Device Management (DM) protocol (i.e., the OMA-DM protocol). In this case, the terminal management server 10 may be implemented as an extended version of an OMA-DM server.

Subsequently, the alternative process information receiving section 11 of the terminal management server 10 receives the phone number of the mobile phone terminal 20, the alternative process information and the phone number of the corresponding entry registered in the address book 27 and stores the received the phone number of the mobile phone terminal 20, the alternative process information and the phone number of the corresponding entry in the terminal information table 16 (step S14).

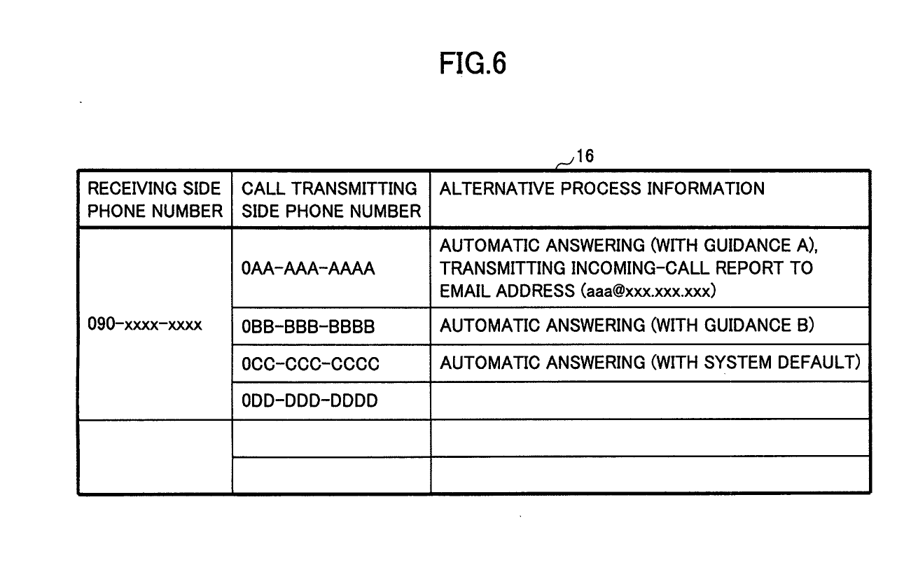

FIG. 6 is a diagram illustrating a configuration example of the terminal information table 16 in the communication system 1 according to the first embodiment. As illustrated in FIG. 6, the terminal information table 16 manages the alternative process information based on combinations of incoming-call receiving side phone numbers and call transmitting side phone numbers. FIG. 6 illustrates the terminal information table 16 that registers the alternative process information and the like in the address book 27 illustrated in FIG. 5. As illustrated in FIG. 6, the phone number “090-xxxx-xxxx” of the mobile phone terminal 20 is registered in an incoming-call receiving side phone number section of the terminal information table 16. In a call transmitting side phone number section of the terminal information table 16, the phone numbers in association of which the alternative process information is registered in the address book 27 are registered. Moreover, the alternative process information registered in the address book 27 is registered in an alternative process information section of the terminal information table 16. Note that the alternative process information is registered in the terminal information table 16 by associating it with the corresponding call transmitting side phone numbers.

Subsequently, the alternative process information receiving section 11 of the terminal management server 10 transmits a response containing a stored result indicating as to whether the alternative process information and the like are stored in the terminal information table 16 to the alternative process information uploading section 23 of the mobile phone terminal 20 (step S15). If the stored result contained in the response indicates that the alternative process information and the like are successfully stored in the terminal information table 16, the alternative process information uploading section 23 stores information indicating the alternative process information and the like have been successfully uploaded in the non-volatile RAM 203. If, on the other hand, the stored result contained in the response indicates that the alternative process information and the like fail to be stored in the terminal information table 16, the alternative process information uploading section 23 may continue attempting to upload the alternative process information and the like in the terminal information table 16 at predetermined time intervals until the alternative process information and the like are successfully uploaded.

Meanwhile, the call transmitting side terminal 40 transmits a call request addressed to the mobile phone terminal 20 regardless of the above-described processes (step S16). The call request addressed to the mobile phone terminal 20 is received by the call request receiving section 31 of the call controller 30. The inquiry section 32 transmits an inquiry about an appropriate process to be performed in response to the call request addressed to the mobile phone terminal 20 to the inquiry receiving section 12 of the terminal management server 10 (step S17). The inquiry section 32 transmits to the inquiry receiving section 12 a combination of the incoming-call receiving side phone number (i.e., the phone number of the mobile phone terminal 20) and the call transmitting side phone number (i.e., the phone number of the call transmitting side terminal 40) contained in the call request addressed to the mobile phone terminal 20 as a parameter of the inquiry about the appropriate process to be performed in response to the call request addressed to the mobile phone terminal 20. Note that the call controller 30 pre-registers identifier information (an IP address, a uniform resource locator (URL), etc.) for communicating with the inquiry receiving section 12 of the terminal management server 10.

Subsequently, the alternative process determining section 13 matches the combination of the incoming-call receiving side phone number and the call transmitting side phone number that is received as the parameter of the inquiry about the appropriate process corresponding to the call request addressed to the mobile phone terminal 20 and the combination of the incoming-call receiving side phone number and the call transmitting side phone number that is registered in association with the alternative process information in the terminal information table 16 to determine the appropriate alternative process corresponding to the call request addressed to the mobile phone terminal 20 (step S18). Subsequently, the inquiry responding section 14 transmits a response containing a determined result assigned by the alternative process determining section 13 to the inquiry section 32 of the call controller 30 (step S19).

Subsequently, the process executing section 33 of the call controller 30 performs the appropriate process determined based on the determined result contained in the response received by the inquiry section 32. If the determined result contains information on the alternative process to be performed; that is, if the determined result indicates that there is information on the appropriate alternative process to be performed, the process executing section 33 performs the appropriate alternative process. Thus, in this case, the call controller 30 performs the alternative process corresponding to the call request from the call transmitting side terminal 40 instead of relaying the call request from the call transmitting side terminal 40 to the mobile phone terminal 20.

If, on the other hand, the determined result contains no information on the alternative process to be performed; that is, if the determined result indicates that there is no information on the corresponding alternative process to be performed, the process executing section 33 relays the call request from the call transmitting side terminal 40 to the mobile phone terminal 20 (step S21). The incoming-call receiving section 24 of the mobile phone terminal 20 receives the call request from the call transmitting side terminal 40 that is relayed via the process executing section 33 of the call controller 30. Subsequently, the incoming-call process determining section 25 determines an appropriate process to be performed in response to the call request from the call transmitting side terminal 40 based on a status of the unattended mode setting of the mobile phone terminal 20 (i.e., whether the unattended mode setting is activated/deactivated), the call transmitting side phone number contained in the call request received from the call transmitting side terminal 40 and the information stored in the address book 27 (step S22). Specifically, if the unattended mode setting of the mobile phone terminal 20 is activated (ON), the incoming-call process determining section 25 acquires the registered alternative process information associated with the phone number in the address book 27 that is identical to the call transmitting side phone number contained in the call request received from the call transmitting side terminal 40 and determines the appropriate process to be performed based on the acquired alternative process information. Note that if the unattended mode setting of the mobile phone terminal 20 is deactivated (OFF), the incoming-call process determining section 25 determines that the incoming-call process executing section 26 of the mobile phone terminal 20 performs an ordinary incoming-call receiving process.

Subsequently, the incoming-call process executing section 26 performs the appropriate process determined by the incoming-call process determining section 25 (step S23). Specifically, if the unattended mode setting of the mobile phone terminal 20 is activated (ON), and the alternative process information is registered in association with the call transmitting side phone number corresponding to the received phone number contained in the call request in the address book 27, the incoming-call process executing section 26 performs the alternative process based on the registered alternative process information. If, on the other hand, the unattended mode setting of the mobile phone terminal 20 is deactivated (OFF), and the alternative process information is not registered in association with the call transmitting side phone number corresponding to the received phone number contained in the call request in the address book 27, the incoming-call process executing section 26 performs the ordinary incoming-call receiving process.

Note that there may be a case where no alternative process information associated with the call transmitting side phone number is registered in the terminal management server 10 but the alternative process information associated with the call transmitting side phone number is registered in the mobile phone terminal 20. This case may represent an example where the alternative process information that is registered in association with the corresponding phone numbers in the address book 27 of the mobile phone terminal 20 is not uploaded into the terminal information table 16 of the terminal management server 10. That is, the alternative process information registered in the address book 27 of the mobile phone terminal 20 is in the middle of being uploaded into the terminal management server 10 (i.e., uploading is not complete) after the user assigns a setting instruction to activate the unattended mode setting of the mobile phone terminal 20.

Thus, the mobile phone terminal 20 may also be able to perform the alternative process even if the uploading of the alternative process information into the terminal information table 16 of the terminal management server 10 is incomplete.

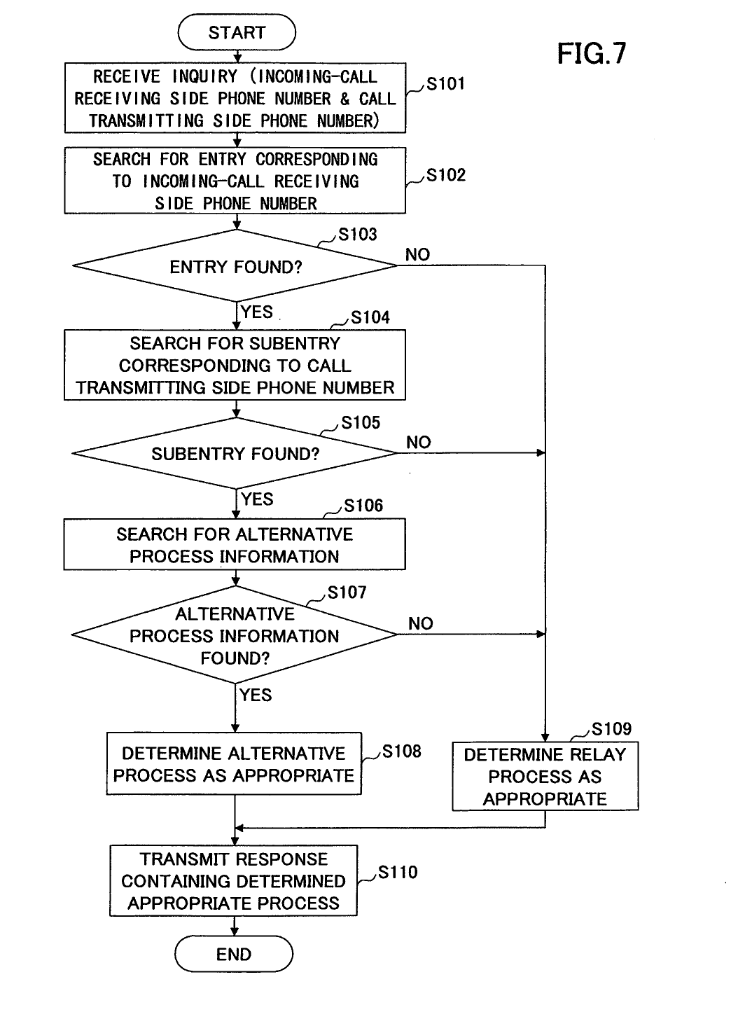

Next, the alternative process determining process performed in step S18 is described in more detail. FIG. 7 is a flowchart illustrating a determining process in which the terminal management server 10 determines an alternative process in the communication system 1 according to the first embodiment.

As illustrated in FIG. 7, the inquiry receiving section 12 receives the inquiry containing the incoming-call receiving side phone number and the call transmitting side phone number from the call controller 30 (step S101). Subsequently, the alternative process determining section 13 searches for an entry (hereinafter called a “current entry”) corresponding to the incoming-call receiving side phone number in the terminal information table 16 (step S102). For example, if the incoming-call receiving side phone number is “090-xxxx-xxxx”, the alternative process determining section 13 searches for the current entry corresponding to the registered incoming-call receiving side phone number “090-xxxx-xxxx” in the terminal information table 16.

If the current entry corresponding to the registered incoming-call receiving side phone number “090-xxxx-xxxx” is found in the terminal information table 16 (“YES” in step S103), the alternative process determining section 13 subsequently searches for a subentry (hereinafter called a “current subentry”) including a call transmitting side phone number identical to the call transmitting side phone number contained in the inquiry received from the call controller 30 (step S104). For example, if the call transmitting side phone number contained in the inquiry from the call controller 30 is “0AA-AAA-AAAA”, the alternative process determining section 13 searches for the subentry including a call transmitting side phone number identical to the call transmitting side phone number “0AA-AAA-AAAA” contained in the inquiry received from the call controller 30.

If the current subentry including a call transmitting side phone number identical to the call transmitting side phone number “0AA-AAA-AAAA” contained in the inquiry is found in the terminal information table 16 (“YES” in step S105), the alternative process determining section 13 subsequently searches for the alternative process information associated with the current subentry (step S106). If the alternative process information is acquired; that is, if there is the alternative process information registered in association with the current subentry in the terminal information table 16 (“YES” in step S107), the alternative process determining section 13 determines an alternative process to be performed based on the acquired alternative process information associated with the current subentry (step S108).

If, on the other hand, the current entry corresponding to the registered incoming-call receiving side phone number “090-xxxx-xxxx” is not found in the terminal information table 16 (“NO” in step S103), if the current subentry including a call transmitting side phone number identical to the call transmitting side phone number “0AA-AAA-AAAA” contained in the inquiry is not found in the terminal information table 16 (“NO” in step S105), or if no alternative process information is registered in association with the current subentry in the terminal information table 16 (“NO” in step S107), the alternative process determining section 13 determines a relay process to relay the call request from the call transmitting side terminal 40 to the mobile phone terminal 20 as the appropriate process (step S109).

Subsequent to step S108 or S109, the inquiry responding section 14 transmits a response containing information on the appropriate process determined by the alternative process determining section 13 to the inquiry section 32 of the call controller 30 (step S110).

Subsequently, the process executing section 33 of the call controller 30 performs the appropriate process determined by the alternative process determining section 13. For example, if the incoming-call receiving side phone number is “090-xxxx-xxxx” and the call transmitting side phone number is “0AA-AAA-AAAA”, the incoming call from the call transmitting side terminal 40 (i.e., person A in this example) is answered with user defined guidance A, and the incoming call report is transmitted to the specific address “aaa@xxx.xxx.xxx”.

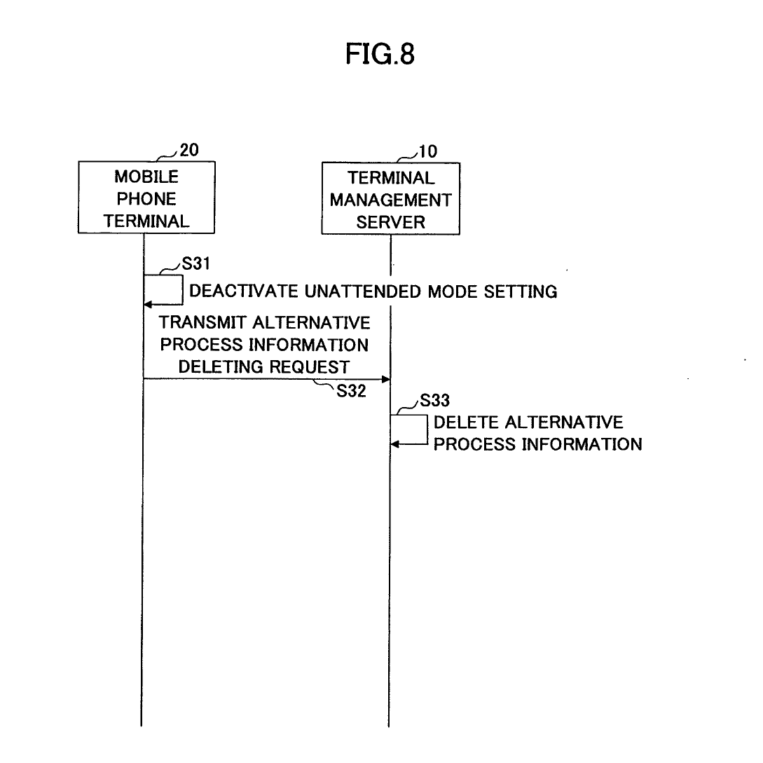

FIG. 8 is a sequence diagram illustrating a sequence of processes to deactivate the unattended mode setting of the mobile phone terminal 20 in the communication system 1 according to the first embodiment. The sequence of processes illustrated in FIG. 8 may be performed when the user (owner) of the mobile phone terminal 20 gets the mobile phone terminal 20 back into his or her hands.

The unattended mode setting section 22 deactivates (OFF) the unattended mode setting of the mobile phone terminal 20 by the user's operation of the buttons of the mobile phone terminal 20 or in response to a request for deactivating the unattended mode setting transmitted from the unattended mode remote setting section 15 of the terminal management server 10 (step S31). In response to the deactivation (OFF) of the unattended mode setting of the mobile phone terminal 20, the alternative process information uploading section 23 transmits a deleting request to delete the alternative process information related to the mobile phone terminal 20 to the terminal management server 10 (step S32). In this process, the alternative process information uploading section 23 transmits the phone number of the mobile phone terminal 20 to the terminal management server 10 as a parameter for the deleting request.

The alternative process information receiving section 11 of the terminal management server 10 deletes, on receiving the deleting request to delete the alternative process information, the entry having the incoming-call receiving side phone number that is identical to the phone number contained in the deleting request from the terminal information table 16 (step S33). Thus, subsequent call requests transmitted from the call transmitting side terminal 40 to the mobile phone terminal 20 are relayed to the mobile phone terminal 20 without performing the alternative process. In addition, since the unattended mode setting of the unattended mode setting section 22 is deactivated (OFF) in the mobile phone terminal 20, the ordinary incoming-call receiving process is performed in response to the call requests from the call transmitting side terminal 40.

Note that alternative process information receiving section 11 may not completely delete the entry related to the deleting request from the terminal information table 16 in response to the deleting request to delete the alternative process information but may instead record a flag (i.e., information indicating invalidity in this case) in the entry related to the deleting request. In this case, the alternative process determining section 13 may determine an appropriate alternative process corresponding to the current entry excluding those associated with the invalidated entry.

Further, in this case, the alternative process information uploading section 23 may not necessarily transmit the alternative process information when the unattended mode setting is activated (ON) again. That is, when the successful uploading of the previous alternative process information is still recorded in the non-volatile RAM 203, the alternative process information uploading section 23 may merely transmit a validating request to validate the previous alternative process information to the terminal management server 10. The alternative process information receiving section 11 may revalidate the invalidated entry based on the validating request received from the alternative process information uploading section 23.

As described above, in the communication system 1 according to the first embodiment, when the unattended mode setting of the mobile phone terminal 20 is activated (ON), the call controller 30 may perform the corresponding alternative processes pre-registered in association with the phone numbers in the address book 27. In the communication system 1 according to the first embodiment, the user (owner) of the mobile phone terminal 20 may define transmitting incoming-call report or forwarding the incoming call to another phone number as alternative processes in association with respective phone numbers of important parties such as important customers. With this configuration, even if the user (owner) of the mobile phone terminal 20 has unintentionally left the mobile phone terminal 20 at home or somewhere in the distance, the user may still be informed of incoming calls received from the important customers. The user (owner) of the mobile phone terminal 20 may also select automatic answering (i.e., automatic announcement) to the incoming call with audio guidance as an alternative process in association with respective phone numbers of less important parties. With this configuration, the incoming call report emails or forwarded incoming calls may be prevented from increasing.

Further, such alternative processes registered at the time of activating the unattended mode setting of the mobile phone terminal 20 may be uploaded to the terminal management server 10. With this configuration, the user of the mobile phone terminal 20 may more effectively utilize the appropriate alternative processes for the different customers or parties based on his or her latest intention compared to the case where the alternative processes are pre-registered in the terminal management server 10.

Note that in the communication system 1 according to the first embodiment, if the call controller 30 performs the alternative process, the call requests from the call transmitting side terminal 40 may not always be relayed to the mobile phone terminal 20 based on the contents of the alternative processes associated with the call transmitting side phone numbers. However, the call controller 30 may, after having performed the appropriate alternative processes, constantly relay the call requests from the call transmitting side terminal 40 to the mobile phone terminal 20. In this case, the call forwarding service may be deactivated to prevent undesirable forwarded incoming calls from increasing.

Further, in the communication system 1 according to the first embodiment, the extended address book 27 that may register alternative process information is illustrated as an example of a destination of the alternative process registration. However, the destination of the alternative process registration may be other management components of the mobile phone terminal 20 that are different from the address book 27. Note that use of the address book 27 to which the user is accustomed may reduce the user's operational complexity.

Further, the unattended mode setting of the mobile phone terminal 20 may be activated when the user of the mobile phone terminal 20 switches off the power of the mobile phone terminal 20. Alternatively, the unattended mode setting of the mobile phone terminal 20 may be activated when the mobile phone terminal 20 detects a sensor (e.g., radio frequency identification RFID or the like) indicating that the mobile phone terminal 20 resides in an out of service area.

Further, in the communication system 1 according to the first embodiment, the terminal management server 10 and the call controller 30 are provided as separate devices; however, the functional components of the terminal management server 10 may be implemented in the call controller 30.

Next, a communication system 2 according to a second embodiment is described. In the communication system 2 according to the second embodiment, components differing from those in the communication system 1 according to the first embodiment are illustrated. Thus, the components not particularly illustrated in the second embodiment may be the same as those in the first embodiment.

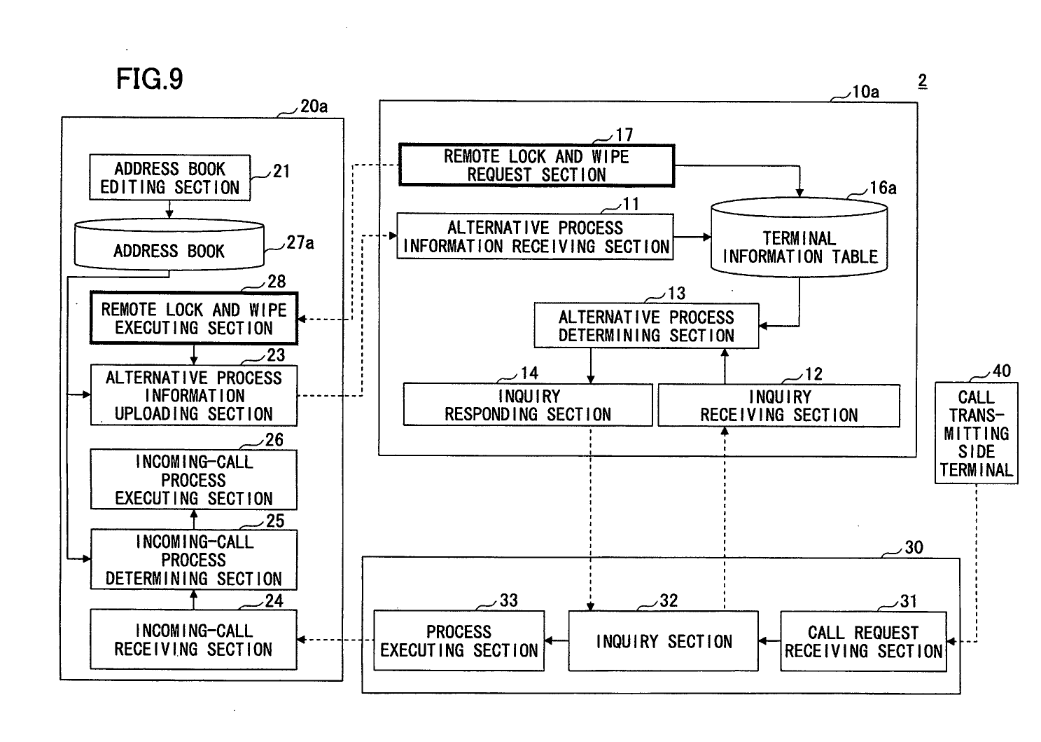

FIG. 9 is a diagram illustrating a configuration example of the communication system 2 according to the second embodiment. The components in FIG. 9 that are similar to those illustrated in FIG. 1 are provided with the same reference numerals and descriptions of such components are thus omitted.

As illustrated in FIG. 9, the communication system 2 includes a terminal server 10a, a mobile phone terminal 20a, a call controller 30, and a call transmitting side terminal 40.

The terminal server 10a in the communication system 2 according to the second embodiment includes almost the same functional configuration as that of the terminal server 10 in the communication system 1 according to the first embodiment. However, the terminal server 10a includes a remote lock and wipe request section 17 in place of the unattended mode remote setting section 15 residing in the terminal server 10. Further, a terminal information table 16a includes a partially different configuration from the terminal information table 16.

The remote lock and wipe request section 17 is configured to request the mobile phone terminal 20a to perform remote lock and remote wipe operations. The lock operation limits operability of the mobile phone terminal. Thus, the remote lock operation remotely locks the operability of the mobile phone terminal. The wipe operation erases data such as an address book stored in the mobile phone terminal. Thus, the remote wipe operation remotely wipes the data stored in the mobile phone terminal. The remote lock and remote wipe operations are similar to those services provided by mobile phone service providers.

The mobile phone terminal 20a in the communication system 2 according to the second embodiment includes almost the same functional configuration as that of the mobile phone terminal 20 in the communication system 1 according to the first embodiment. However, the mobile phone terminal 20a includes a remote lock and wipe executing section 28 in place of the unattended mode remote setting section 22 residing in the mobile phone terminal 20. Further, an address book 27a of the mobile phone terminal 20a in the communication system 2 according to the second embodiment includes a partially different configuration from the address book 27 of the mobile phone terminal 20 in the communication system 1 according to the first embodiment.

The remote lock and wipe executing section 28 is configured to perform a remote lock operation or a remote wipe operation on the mobile phone terminal 20a in response to a request received from the remote lock and wipe request section 17. Note that the communications between the remote lock and wipe request section 17 and the remote lock and wipe executing section 28 may be performed by remote lock and wipe management functionalities defined by the standardized OMA-DM protocol.

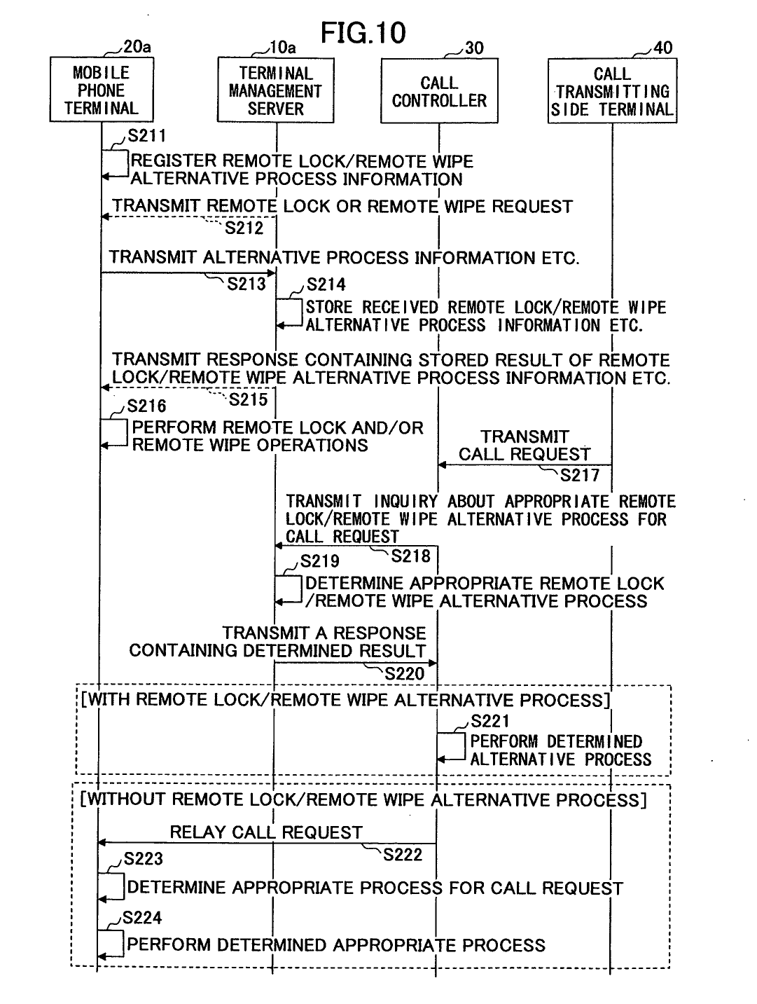

Next, a sequence of processes carried out in the communication system 2 according to the second embodiment is described. FIG. 10 is a sequence diagram illustrating the sequence of processes carried out in the communication system 2 according to the second embodiment.

First, the address book editing section 21 registers alternative process information and the like in the address book 27a based on an instruction input by the owner (i.e., operator) of the mobile phone terminal 20a (step S211).

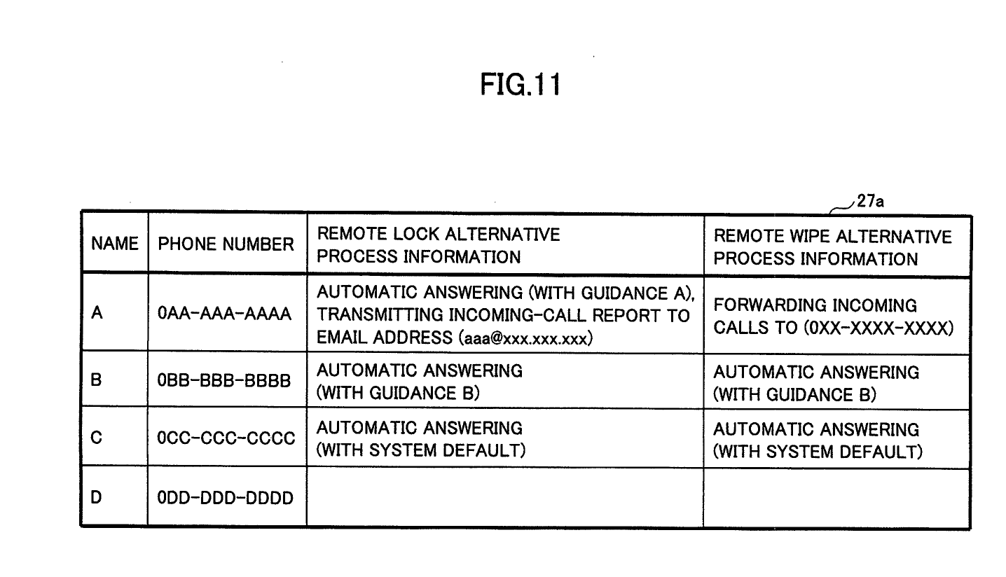

FIG. 11 is a diagram illustrating a configuration example of the address book 27a of the mobile phone terminal 20a in the communication system 2 according to the second embodiment. As illustrated in FIG. 10, the address book 27a is configured to register a name, a phone number, and alternative process information when locking and alternative process information when wiping for each entry. The alternative process information when locking indicates the alternative process information utilized when the operability of the mobile phone terminal 20a is remotely locked. The alternative process information when wiping indicates the alternative process information utilized when the data stored in the mobile phone terminal 20a is remotely wiped. Specifically, in the communication system 2 according to the second embodiment, the alternative process information utilized when the operability of the mobile phone terminal 20a is locked (hereinafter called “remote lock alternative process information”) may be separately registered from the alternative process information utilized when the data stored in the mobile phone terminal 20a is wiped (hereinafter called “remote wipe alternative process information”). Thus, the remote lock alternative process information and the remote wipe alternative process information may be separately registered (step S211). Note that in step S211, one of the remote lock alternative process information and the remote wipe alternative process information may be registered or neither of them may be registered. Further, the contents of the remote lock alternative process information and the contents of the remote wipe alternative process information may be the same. Note that the remote lock alternative process information and the remote wipe alternative process information may be simply called the “alternative process information” as a generic term.

As illustrated in FIG. 11, the remote lock alternative process information for an incoming call from a phone number (i.e., call transmitting side phone number) “0AA-AAA-AAAA” of a person A registered in the address book 27a includes automatic answering (i.e., automatic announcement) to the incoming call from the person A with user defined guidance A (i.e., one example of the user defined audio guidance), and transmission of the incoming call report to a specific address (e.g., email address of a PC at work) “aaa@xxx.xxx.xxx” other than that of the mobile phone terminal 20a of the user (owner). Further, the remote wipe alternative process information for the incoming call from the phone number “0AA-AAA-AAAA” of the person A registered in the address book 27a includes transmission of the incoming call to a phone number “0XX-XXXX-XXXX”.

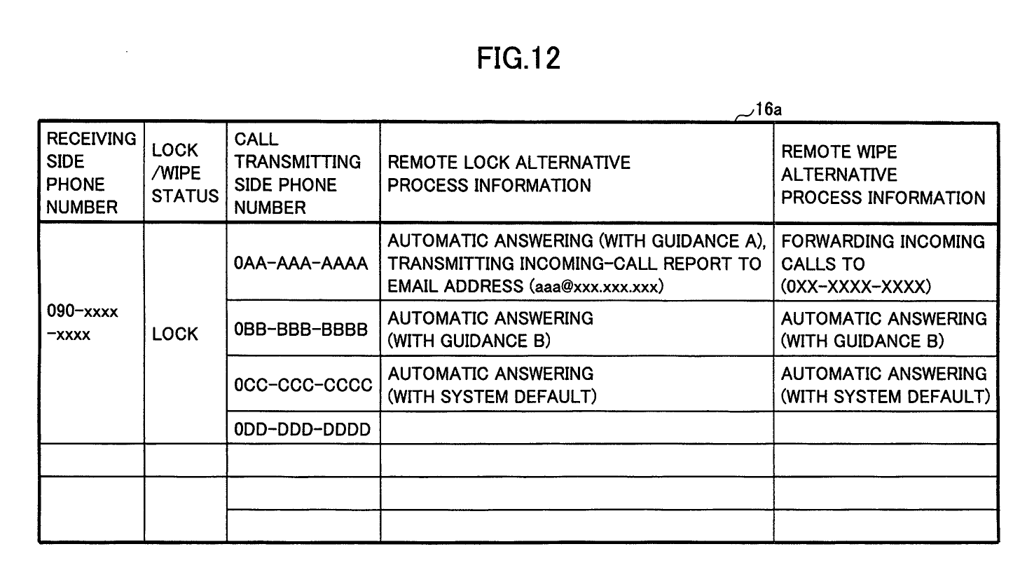

Subsequently, the owner of the mobile phone terminal 20a inputs a remote lock executing instruction or a remote wipe executing instruction to the remote lock and wipe request section 17 of the terminal management server 10a. In response to the remote lock executing instruction or the remote wipe executing instruction, the remote lock and wipe request section 17 transmits a remote lock executing request or a remote wipe executing request to the mobile phone terminal 20a (step S212). The remote lock and wipe request section 17 creates entries of phone numbers to which the remote lock or the remote wipe alternative process is to be performed in the terminal information table 16a (see FIG. 12) before or after the transmission of the remote lock executing request or remote wipe executing request, and registers the lock/wipe status for the entries. The lock/wipe status is a specific example of information on a remote operation of the mobile phone terminal 20a, specifically, the remote operation to attain security. More specifically, the lock/wipe status is information indicating whether the lock or wipe operation is set in the mobile phone terminal 20a.

Note that the remote lock or the remote wipe request instruction may be input to the remote lock and wipe request section 17 via a push-button telephone or via a Web interface in a similar manner as the input operation for the unattended mode remote setting section 15. Further, the remote lock or the remote wipe request instruction may be input based on a method of a generally provided remote lock service or remote wipe service. The remote lock executing request or the remote wipe executing request may be transmitted via devices other than the terminal management server 10a. In this case, the terminal management server 10a may not include the remote lock and wipe request section 17.

The remote lock and wipe executing section 28 transmits, on receiving the remote lock executing request or the remote wipe executing request, a remote lock executing request receiving report or a remote wipe executing request receiving report to the alternative process information uploading section 23. In response to the remote lock executing request receiving report or the remote wipe executing request receiving report, the alternative process information uploading section 23 uploads (transmits) the alternative process information and the phone number of the corresponding entry registered in the address book 27a to the terminal management server 10a (step S213). In this step, the alternative process information uploading section 23 may also upload (transmit) the phone number of the mobile phone terminal 20a recorded in the ROM 201 or non-volatile RAM 203 to the terminal management server 10a.

Subsequently, the alternative process information receiving section 11 of the terminal management server 10a receives the phone number of the mobile phone terminal 20a, the alternative process information and the phone number of the corresponding entry registered in the address book 27a and stores the received the phone number of the mobile phone terminal 20a, the alternative process information and the phone number of the corresponding entry in the terminal information table 16a (step S214).

FIG. 12 is a diagram illustrating a configuration example of the terminal information table 16a in the communication system 2 according to the second embodiment. As illustrated in FIG. 6, the terminal information table 16a manages the lock/wipe status of the mobile phone terminals 20a by the incoming-call receiving side phone numbers and also manages the alternative process information based on combinations of incoming-call receiving side phone numbers and call transmitting side phone numbers. FIG. 12 illustrates the terminal information table 16a that registers the remote lock and remote wipe alternative process information and the like in the address book 27a illustrated in FIG. 11. As illustrated in FIG. 12, “LOCK” is registered in a lock/wipe status section of the terminal management table 16a when the remote lock operation is performed by the mobile phone terminal 20a (corresponding to the incoming-call receiving side phone number). Similarly, “WIPE” is registered, though not illustrated in FIG. 12, in the lock/wipe status section of the terminal management table 16a when the remote wipe operation is performed by the mobile phone terminal 20a. Note that the remote lock and wipe request section 17 registers the lock/wipe status of the mobile phone terminal 20a in step S212, in which the remote lock and wipe request section 17 transmits the remote lock or remote wipe request. In a call transmitting side phone number section of the terminal information table 16a, the phone numbers in association of which the alternative process information is registered in the address book 27a are registered. Moreover, the remote lock alternative process information registered in the address book 27a is registered in a remote lock alternative process information section of the terminal information table 16a. Note that the remote lock alternative process information is registered in the terminal information table 16a by associating it with the corresponding call transmitting side phone numbers. Similarly, the remote wipe alternative process information registered in the address book 27a is registered in a remote wipe alternative process information section of the terminal information table 16a. Note that the remote wipe alternative process information is registered in the terminal information table 16a by associating it with the corresponding call transmitting side phone numbers.

Note that alternatively, the alternative process information uploading section 23 may upload the lock/wipe status of the mobile phone terminal 20a together with the remote lock and remote wipe alternative process information in step S213. Accordingly, even if the remote lock executing request or the remote wipe executing request is transmitted by devices other than the terminal management server 10a, the alternative process information receiving section 11 may register the lock/wipe status of the mobile phone terminal 20a in the terminal information table 16a.

Subsequently, the alternative process information receiving section 11 of the terminal management server 10a transmits a response containing a stored result indicating whether the remote lock and remote wipe alternative process information and the like are stored in the terminal information table 16a to the alternative process information uploading section 23 of the mobile phone terminal 20a (step S215). If the stored result contained in the response indicates that the remote lock and remote wipe alternative process information and the like are successfully stored in the terminal information table 16a, the alternative process information uploading section 23 stores information indicating the remote lock and remote wipe alternative process information and the like have been successfully uploaded in the non-volatile RAM 203. If, on the other hand, the stored result contained in the response indicates that the remote lock and remote wipe alternative process information and the like fail to be stored in the terminal information table 16a, the alternative process information uploading section 23 may continue attempting to upload the remote lock and remote wipe alternative process information and the like in the terminal information table 16a at predetermined time intervals until the remote lock and remote wipe alternative process information and the like are successfully uploaded. However, if the alternative process information uploading section 23 receives a remote lock deactivating request or a remote wipe deactivating request from the remote lock and wipe executing section 17 while attempting to unload the remote lock and remote wipe alternative process information and the like in the terminal information table 16a at the predetermined time intervals, the alternative process information uploading section 23 terminates the uploading attempts.

Subsequently, the remote lock and wipe executing section 28 performs the remote lock operation or the remote wipe operation on the mobile phone terminal 20a (step S216). If the remote lock and wipe executing section 28 performs the remote wipe operation, the contents of the address book 27a of the mobile phone terminal 20a may also be erased (wiped). Note that when the remote lock and wipe executing section 28 performs the remote wipe operation, the remote lock and wipe executing section 28 generally performs the remote lock operation simultaneously. Note that the remote lock operation or the remote wipe operation may be performed by the remote lock and wipe executing section 28 on completing the uploading of the remote lock and remote wipe alternative process information and the like in step S213.

As illustrated in FIG. 10, steps subsequent to step S217 in the communication system 2 according to the second embodiment are similar to those steps subsequent to step S16 in the communication system 1 according to the first embodiment as illustrated in FIG. 4. However, when inquiry section 32 of the call controller 30 transmits an inquiry about an appropriate alternative process to be performed to the alternative process determining section 13 of the terminal management server 10a (step S218), the alternative process determining section 13 may determine the appropriate alternative process based on whether the mobile phone terminal 20a (with the incoming-call receiving side phone number) is “LOCK” or “WIPE” (i.e., lock and wipe) (step S219).

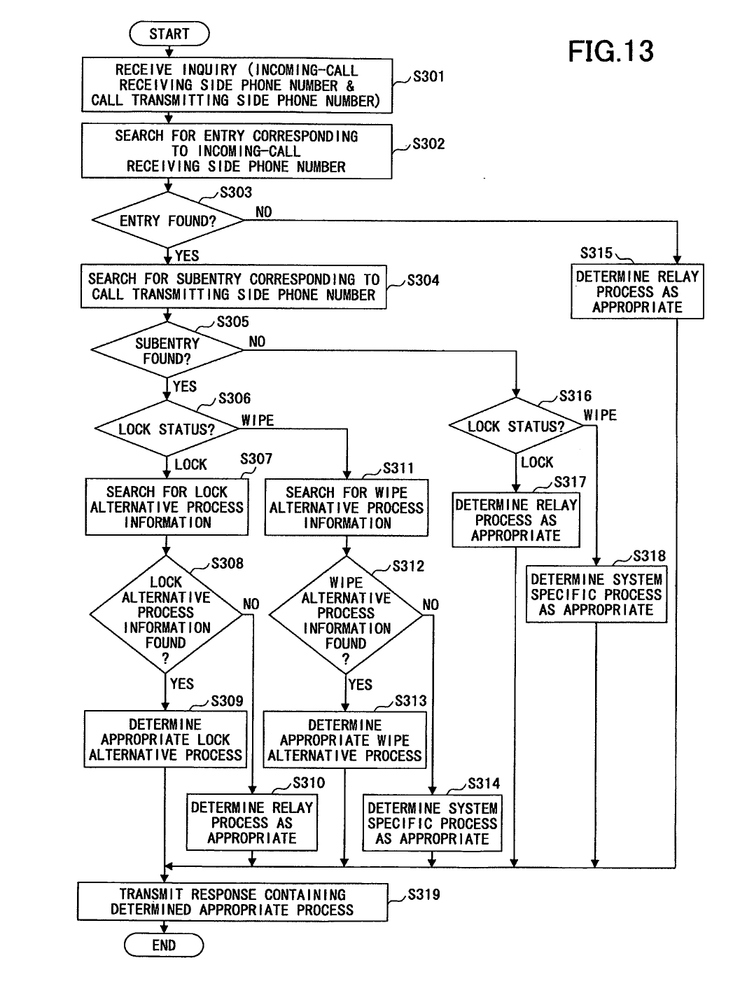

The determination of the appropriate alternative process is described in more detail. FIG. 13 is a flowchart illustrating a determining process in which the terminal management server 10a determines an alternative process in the communication system 2 according to the second embodiment.

Note that steps S301 through S305 in FIG. 13 are similar to steps S101 through S105 in FIG. 4, and descriptions of the processes in steps S301 through S305 are thus omitted.

The alternative process determining section 13 determines whether the value of the lock/wipe status section registered corresponding to the current entry indicates “LOCK” (step S306). If “LOCK” is registered in the lock/wipe status section corresponding to the current entry, the alternative process determining section 13 subsequently searches for the lock alternative process information associated with the current subentry (step S307). If the lock alternative process information is acquired; that is, if there is the lock alternative process information registered in association with the current subentry in the terminal information table 16a (“YES” in step S308), the alternative process determining section 13 determines a lock alternative process to be performed based on the acquired lock alternative process information associated with the current subentry (step S309). If, on the other hand, the lock alternative process information is not acquired; that is, if there is no lock alternative process information registered in association with the current subentry in the terminal information table 16a (“NO” in step S308), the alternative process determining section 13 determines a relay process to relay the call request from the call transmitting side terminal 40 to the mobile phone terminal 20a as the appropriate process to be performed (step S310).

If “WIPE” is registered in the lock/wipe status section corresponding to the current entry, the alternative process determining section 13 subsequently searches for the wipe alternative process information associated with the current subentry (step S311). If the wipe alternative process information is acquired; that is, if there is the wipe alternative process information registered in association with the current subentry in the terminal information table 16a (“YES” in step S312), the alternative process determining section 13 determines a wipe alternative process to be performed based on the acquired wipe alternative process information associated with the current subentry (step S313). If, on the other hand, the wipe alternative process information is not acquired; that is, if there is no wipe alternative process information registered in association with the current subentry in the terminal information table 16a (“NO” in step S312), the alternative process determining section 13 determines a predetermined process (hereinafter called a “system specific process”) as the appropriate process to be performed (step S314). The system specific process includes a process to redirect incoming calls addressed to an incoming-call receiving side terminal (i.e., mobile phone terminal 20a) such as automatic answering (i.e., automatic announcement) to an incoming call with system specific audio guidance or forwarding an incoming call to a voice message service such that at least the incoming calls are not received by the incoming-call receiving side terminal.

Further, if there is no entry corresponding to the incoming-call receiving side phone number (“NO” in step S303), the alternative process determining section 13 determines a relay process to relay the call request from the call transmitting side terminal 40 to the mobile phone terminal 20a as the appropriate process (step S315). If there is no subentry corresponding to the call transmitting side phone number (“NO” in step S305), the alternative process determining section 13 determines whether the value of the lock/wipe status section registered corresponding to the current entry indicates “LOCK” (step S316). If “LOCK” is registered in the lock/wipe status section corresponding to the current entry, the alternative process determining section 13 determines a relay process to relay the call request from the call transmitting side terminal 40 to the mobile phone terminal 20a as the appropriate process (step S317). If “WIPE” is registered in the lock/wipe status section corresponding to the current entry, the alternative process determining section 13 determines a system specific process as the appropriate process to be performed (step S318).

Subsequent to step S309, S310, S314, S315, S317 or S318, the inquiry responding section 14 transmits a response containing information on the appropriate process determined by the alternative process determining section 13 to the inquiry section 32 of the call controller 30 (step S319).

Note that if the remote lock operation is deactivated, a sequence of the processes similar to that for the deactivation (OFF) of the unattended mode setting illustrated in FIG. 8 may be carried out. Thus, a call request transmitted from the call transmitting side terminal 40 after the deactivation of the remote lock operation may be relayed to the mobile phone terminal 20a in an ordinary manner.

As described above, in the communication system 2 according to the second embodiment, the owner of the mobile phone terminal 20a may cause the mobile phone terminal 20a to upload the alternative process information and the like in cooperation with the remote lock and/or remote wipe operations. The remote lock and remote wipe operations may be performed for attaining the security of the mobile phone terminal when the user or owner of the mobile phone terminal fails to have the mobile phone terminal at hand. Thus, with these operations, the mobile phone terminal 20a may automatically detect that the mobile phone terminal 20a is not in the hands of its owner and uploads the alternative process information and the like without deliberate activation of the unattended mode setting operated by the owner. As a result, a report indicating that there are important call requests may be transmitted to the owner of the mobile phone terminal 20a via the call controller 30.

Further, in the communication system 2 according to the second embodiment, the alternative process information may not be managed by the terminal management server 10a in advance but may be uploaded by the mobile phone terminal 20a while the owner of the mobile phone terminal 20a performs the remote lock operation and the like. Accordingly, an appropriate alternative process may be determined based on the alternative process information that is obtained when the mobile phone terminal 20a automatically detects that the mobile phone terminal 20a is not in the hands of the owner of the mobile phone terminal 20a.

Further, devious use of the mobile phone terminal 20a may effectively be prevented by combining temporarily terminating or locking the accessibility to a universal subscriber identity module (USIM) and the wipe operation.

Note that in this example, the system specific process is performed if the lock/wipe status is “WIPE” and the wipe alternative process information is not registered. With this configuration, the mobile phone terminal 20a may not be overwritten with new information after the wipe operation is performed on the mobile phone terminal 20a. For example, if the call request from the call transmitting side terminal 40 were relayed to the mobile phone terminal 20a after the wipe operation, a new incoming-call history would be recorded in the mobile phone terminal 20a. In this case, the phone number of the call transmitting side terminal 40 might undesirably be stolen based on the new incoming-call history recorded in the mobile phone terminal 20a, which is not in the hands of its owner. Thus, the system specific process is performed on the mobile phone terminal 20a such that the mobile phone terminal 20a remains unaffected after the wipe operation.

Next, a communication system 3 according to a third embodiment is described. In the communication system 3 according to the third embodiment, components differing from those in the communication system 1 according to the first embodiment or the communication system 2 according to the second embodiment are illustrated. Thus, the components not particularly illustrated in the second embodiment may be the same as those in the first or second embodiment.

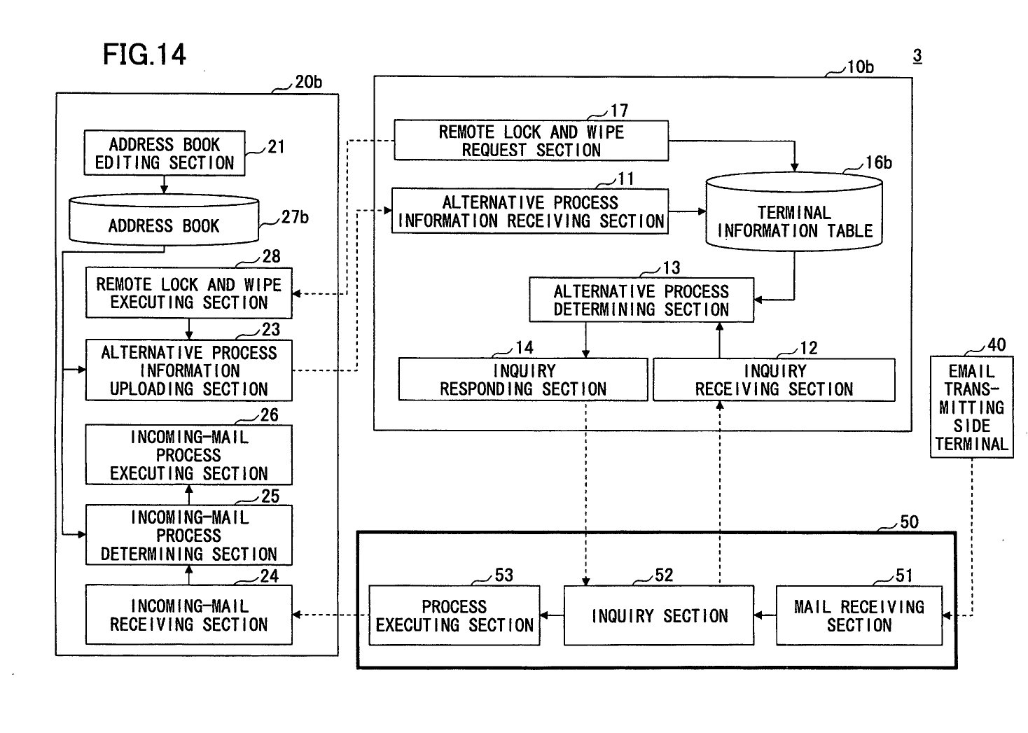

FIG. 14 is a diagram illustrating a configuration example of the communication system 3 according to the third embodiment. The components in FIG. 14 that are similar to those illustrated in FIG. 1 or FIG. 9 are provided with the same reference numerals and descriptions of such components are thus omitted.

In the communication system 3 according to the third embodiment, items communicated between the transmitting side terminal 40 and a mobile phone terminal 20b are electronic mails (emails or mails). Accordingly, the communication system 3 according to the third embodiment includes a mail server 50 in place of the call controller 30. However, the communication system 3 according to the third embodiment may include the call controller 30 in addition to the mail server 50.

The mail server 50 is a computer configured to relay emails from the transmitting side to the receiving side based on a protocol such as a simple mail transfer protocol (SMTP). The mail server 50 includes an email receiving section 51, an inquiry section 52, and a process executing section 53. The email receiving section 51 is configured to directly or indirectly receive an email relay request (i.e., communication request in the third embodiment) transmitted from an email transmitting side terminal 40. The inquiry section 52 is configured to transmit an inquiry about an appropriate process corresponding to the received email to a terminal management server 10b. The process executing section 53 is configured to perform an appropriate process based on a determined result on the inquiry.

Note that a sequence of processes carried out in the communication system 3 according to the third embodiment may be similar to that carried out in the communication system 2 according to the second embodiment illustrated in FIG. 10. However, an address book 27b at least registers email addresses.

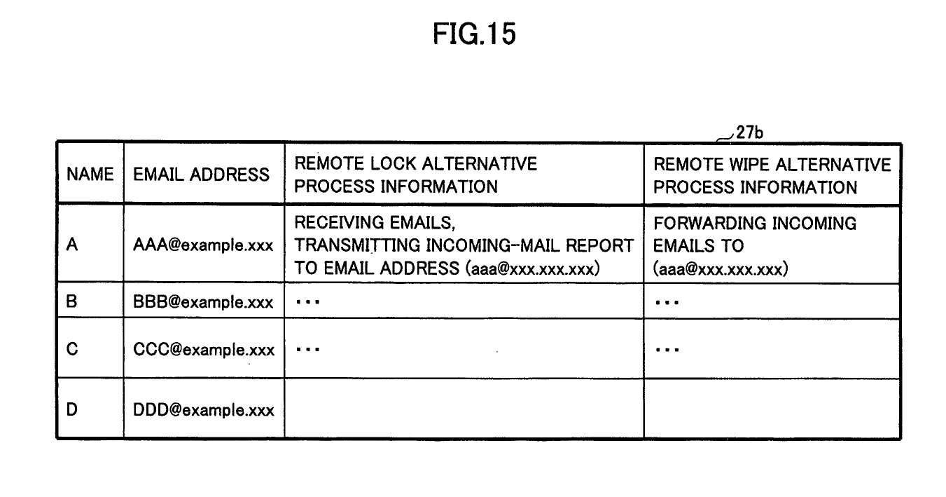

FIG. 15 is a diagram illustrating a configuration example of the address book 27b of the mobile phone terminal 20b in the communication system 3 according to the third embodiment. As illustrated in FIG. 10, the address book 27b is configured to register a name, an email address, and alternative process information when locking (hereinafter called “lock alternative process information”), and alternative process information when wiping (hereinafter called “wipe alternative process information”) for each entry. Note that examples of alternative processes defined by the lock alternative process information or the wipe alternative process information includes automatic transmission of a user defined or a system specific email response to the incoming mails, transmitting an incoming mail report to a specified email address, and forwarding or transferring the incoming mails to a specified email address.

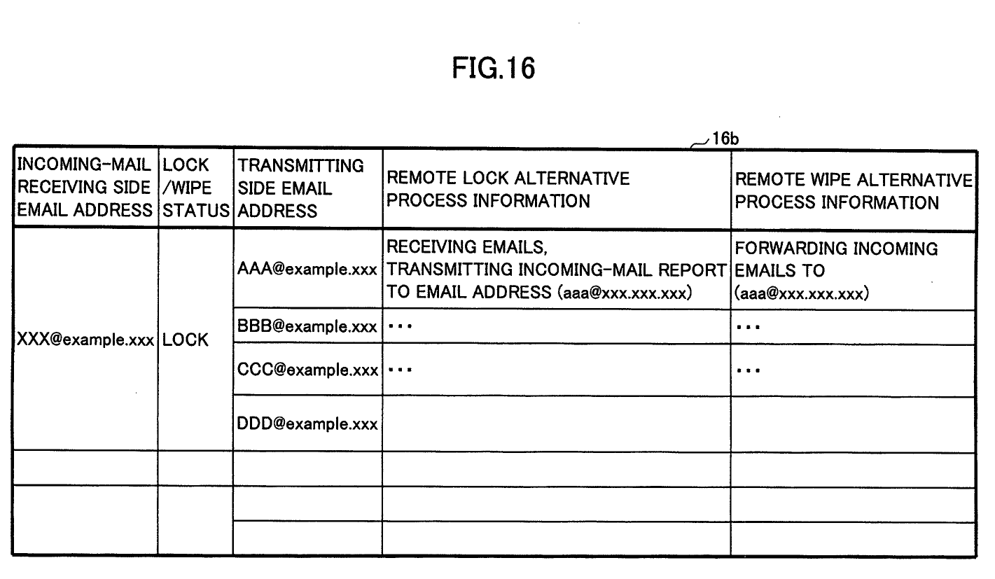

Thus, the following information may be registered in a terminal information table 16b of the terminal management server 10b. FIG. 16 is a diagram illustrating a configuration example of the terminal information table 16b in the communication system 3 according to the third embodiment. As illustrated in FIG. 16, the terminal information table 16b manages the lock/wipe status of the mobile phone terminals 20b by the incoming-mail receiving side email addresses and also manages the lock and wipe alternative process information based on combinations of incoming-mail receiving side email addresses and transmitting side email addresses.

FIG. 16 illustrates the terminal information table 16b that registers the remote lock and remote wipe alternative process information and the like in the address book 27b illustrated in FIG. 15. Specifically, an email address “XXX@example.xxx” of the mobile phone terminal 20b is registered in an incoming-mail receiving side email address section of the terminal information table 16b. The terminal information table 16b further registers the transmitting side email addresses, the remote lock alternative process information, and the remote wipe alternative process information registered in the address book 27b of the mobile phone terminal 20b.

The alternative process determining section 13 performs the sequence of the processes illustrated in FIG. 13, and then determines the remote lock or remote wipe alternative process in response to the inquiry received from the inquiry section 52 of the mail server 50. That is, the inquiry transmitted from the inquiry section 52 contains the email address of the mobile phone terminal 20b (i.e., incoming-mail receiving side email address) and the email address of the transmitting side terminal 40 (i.e., transmitting side email address). The alternative process determining section 13 matches the combination of the incoming-mail receiving side email address and the transmitting side email address contained in the inquiry received from the inquiry section 52 and the combination of the incoming-mail receiving side email address and the transmitting side email address registered in the terminal information table 16b.

Note that an email from the transmitting side email address (i.e., email transmitting side terminal 40) may be relayed to the incoming-mail receiving side email address (i.e., mobile phone terminal 20b), if the lock/wipe status of the incoming-mail receiving side email address indicates “LOCK” and the lock alternative process information corresponding to the transmitting side email address of the received email is not registered in the terminal information table 16b. With this configuration, emails may not be necessarily stored in the mail server 50, which may release resources for the mail server 50.

Further, an email from the transmitting side email address (i.e., email transmitting side terminal 40) may be stored in the mail server 50, if the lock/wipe status of the incoming-mail receiving side email address indicates “WIPE” and the wipe alternative process information corresponding to the transmitting side email address of the received email is not registered in the terminal information table 16b. With this configuration, new incoming emails may not be received by the mobile phone terminal 20b that is not in the hands of its owner after the user of the mobile phone terminal 20b has performed the remote wipe operation.

Other advantages provided by the communication system 3 according to the third embodiment may be obvious from the illustrations of the communication system 1 according to the first embodiment or the communication system 2 according to the second embodiment, and their descriptions are thus omitted.

As described above, in the communication system 3 according to the third embodiment, the alternative processes may also be performed in response to incoming emails addressed to the mobile phone terminal 20b even if the mobile phone terminal 20b is not in the hands of the owner of the mobile phone terminal 20b. Thus, the owner of the mobile phone terminal 20b may receive a report indicating that the mobile phone terminal 20b has received an important email.

Note that in the descriptions of the above embodiments, the call request and the mail transfer request are given as specific examples of the communication request addressed to the mobile phone terminal. However, the scope of the term “communication request” may expand due to an increase in new communication technologies (communication methods) achieved by the mobile phone terminals.

In the communication systems according to the above embodiments, even if the user (owner) of the mobile phone terminal fails to have the mobile phone terminal at hand, the communication request addressed to the mobile phone terminal may be appropriately handled.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A method for determining, by a computer, an alternative process, the method comprising:
receiving a communication request addressed to a mobile phone terminal from a transmitting side terminal, the communication request containing a first combination of a receiving side identifier information of the mobile phone terminal and a transmitting side identifier information of the transmitting side terminal; and
determining the alternative process to be performed, instead of relaying the communication request received from the transmitting side terminal to the mobile phone terminal in response to the communication request received from the transmitting side terminal, corresponding to the transmitting side identifier information contained in the communication request based on the first combination of the receiving side identifier information and the transmitting side identifier information contained in the communication request and alternative process information specifying the alternative process to be performed based on a second combination of the receiving side identifier information of the mobile phone terminal and the transmitting side identifier information of the transmitting side terminal managed in an alternative process information manager.

2. The method as claimed in claim 1, the method further comprising:
receiving the alternative process information specifying the alternative process to be performed from the mobile phone terminal; and
registering the received alternative process information in the alternative process information manager.

3. The method as claimed in claim 2,
wherein the alternative process information registered in the alternative process information manager is transmitted from the mobile phone terminal based on a remote operation carried out on the mobile phone terminal.

4. The method as claimed in claim 3,
wherein the alternative process information transmitted from the mobile phone terminal is further managed based on different types of the remote operation carried out on the mobile phone terminal in the alternative process information manager, and
wherein the alternative process to be performed corresponding to the transmitting side identifier information contained in the communication request is determined based on a corresponding one of the different types of the remote operation carried out on the mobile phone terminal.

5. The method as claimed in claim 1,
wherein the receiving side identifier information and the transmitting side identifier information of the first and the second combinations each include one of a phone number and an email address.

6. An alternative process determining apparatus comprising:
an alternative process information manager configured to manage alternative process information specifying an alternative process to be performed based on a first combination of a receiving side identifier information of a mobile phone terminal and a transmitting side identifier information of a transmitting side terminal; and
an alternative process determining part configured to receive a communication request addressed to the mobile phone terminal from the transmitting side terminal, the communication request containing a second combination of the receiving side identifier information of the mobile phone terminal and the transmitting side identifier information of the transmitting side terminal, and determine the alternative process to be performed, instead of relaying the communication request received from the transmitting side terminal to the mobile phone terminal in response to the communication request received from the transmitting side terminal, corresponding to the transmitting side identifier information contained in the communication request based on the second combination of the receiving side identifier information and the transmitting side identifier information contained in the communication request and the alternative process information specifying the alternative process to be performed based on the first combination of the receiving side identifier information of the mobile phone terminal and the transmitting side identifier information of the transmitting side terminal managed in the alternative process information manager.

7. The alternative process determining apparatus as claimed in claim 6, the apparatus further comprising:
an alternative process information receiver configured to receive the alternative process information specifying the alternative process to be performed from the mobile phone terminal and register the received alternative process information in the alternative process information manager.

8. The alternative process determining apparatus as claimed in claim 7,
wherein the alternative process information registered in the alternative process information manager is transmitted from the mobile phone terminal based on a remote operation carried out on the mobile phone terminal.

9. The alternative process determining apparatus as claimed in claim 8,
wherein the alternative process information manager further manages the alternative process information transmitted from the mobile phone terminal based on different types of the remote operation carried out on the mobile phone terminal in the alternative process information manager, and
wherein the alternative process determining part determines the alternative process to be performed corresponding to the transmitting side identifier information contained in the communication request based on a corresponding one of the different types of the remote operation carried out on the mobile phone terminal.

10. The alternative process determining apparatus as claimed in claim 6,
wherein the receiving side identifier information and the transmitting side identifier information of the first and the second combinations each include one of a phone number and an email address.

11. An alternative process determining apparatus comprising:
a processor configured to execute a procedure, the procedure comprising:
receiving a communication request addressed to a mobile phone terminal from a transmitting side terminal, the communication request containing a first combination of a receiving side identifier information of the mobile phone terminal and a transmitting side identifier information of the transmitting side terminal; and
determining the alternative process to be performed, instead of relaying the communication request received from the transmitting side terminal to the mobile phone terminal in response to the communication request received from the transmitting side terminal, corresponding to the transmitting side identifier information contained in the communication request based on the first combination of the receiving side identifier information and the transmitting side identifier information contained in the communication request and alternative process information specifying the alternative process to be performed based on a second combination of the receiving side identifier information of the mobile phone terminal and the transmitting side identifier information of the transmitting side terminal managed in an alternative process information manager.

12. A non-transitory computer-readable medium having a computer program for executing a procedure for determining an alternative process embodied therein, the computer program causing, when processed by a processor, the computer to execute the procedure comprising:
receiving a communication request addressed to a mobile phone terminal from a transmitting side terminal, the communication request containing a first combination of a receiving side identifier information of the mobile phone terminal and a transmitting side identifier information of the transmitting side terminal; and
determining the alternative process to be performed, instead of relaying the communication request received from the transmitting side terminal to the mobile phone terminal in response to the communication request received from the transmitting side terminal, corresponding to the transmitting side identifier information contained in the communication request based on the first combination of the receiving side identifier information and the transmitting side identifier information contained in the communication request and alternative process information specifying the alternative process to be performed based on a second combination of the receiving side identifier information of the mobile phone terminal and the transmitting side identifier information of the transmitting side terminal managed in an alternative process information manager.

13. The medium as claimed in claim 12, the procedure further comprising:
receiving the alternative process information specifying the alternative process to be performed from the mobile phone terminal; and
registering the received alternative process information in the alternative process information manager.

14. The medium as claimed in claim 13,
wherein the alternative process information registered in the alternative process information manager is transmitted from the mobile phone terminal based on a remote operation carried out on the mobile phone terminal.

15. The medium as claimed in claim 14,
wherein the alternative process information transmitted from the mobile phone terminal is further managed based on different types of the remote operation carried out on the mobile phone terminal in the alternative process information manager, and
wherein the alternative process to be performed corresponding to the transmitting side identifier information contained in the communication request is determined based on a corresponding one of the different types of the remote operation carried out on the mobile phone terminal.

16. The medium as claimed in claim 12,
wherein the receiving side identifier information and the transmitting side identifier information of the first and the second combinations each include one of a phone number and an email address.

17. A mobile phone terminal comprising:
a process information manager configured to manage, on receiving a communication request addressed to a mobile phone terminal from a transmitting side terminal, an executing process information that specifies a process to be executed; and
an alternative process information transmitter configured to transmit the executing process information managed by the process information manager as the alternative process information to the alternative process determining part as claimed in claim 6.

18. The mobile phone terminal as claimed in claim 17,
wherein the process information manager manages the executing process information as part of information contained in an address book.

19. The mobile phone terminal as claimed in claim 17, the mobile phone terminal further comprising:
a communication request receiver configured to receive the communication request from the transmitting side terminal, the communication request containing the second combination of the receiving side identifier information of the mobile phone terminal and the transmitting side identifier information of the transmitting side terminal;
a second alternative process determining part configured to determine, in response to the communication request received from the transmitting side terminal, a second alternative process to be performed corresponding to the transmitting side identifier contained in the communication request received from the transmitting side terminal based on the second combination of the receiving side identifier information and the transmitting side identifier information contained in the communication request and a third combination of a receiving side identifier and a transmitting side identifier contained in the process information manager; and
a process executing part configured to execute the second alternative process determined by the second alternative process determining part.
